(19) United States
(12) Patent Application Publication
(10) Pub. No.: US 2005/0204187 A1
(43) Pub. Date: Sep. 15, 2005

(54) System and method for managing blocks in flash memory

(76) Inventors: Charles C. Lee, Sunnyvale, CA (US); Ben-Wei Chen, Fremont, CA (US); Szu-Kuang Chou, Cupertino, CA (US)

Correspondence Address: SAWYER LAW GROUP LLP, P.O. Box 51418, Palo Alto, CA, 94303, US

(21) Appl. No.: 10/799,039

(22) Filed: Mar. 11, 2004

(51) Int. Cl. G06F 12/08; G06F 12/16

(52) U.S. Cl. 714/8; 711/103; 711/165; 711/203

(57) ABSTRACT

A flash memory controller is disclosed. The flash memory controller includes a processor for executing at least one operation and arbitration logic coupled to the processor. Data from the arbitration logic allows the processor to perform the at least one operation for a flash memory device. In one aspect of the present invention, the processor utilizes data from the arbitration logic to direct a search for available blocks to the particular flash memory device. In another aspect of the present invention, the processor utilizes an internal buffer within the flash memory device to store valid data during the search before the valid data is relocated. As a result, the search time for available blocks is greatly shortened and the need for an external buffer is eliminated. Consequently, the speed at which block management operations are performed is significantly increased.

### FIELD OF THE INVENTION

The present invention relates to memory systems, and more particularly to a system and method for managing blocks in flash memory.

### BACKGROUND OF THE INVENTION

Flash memory has been replacing traditional magnetic hard disks as storage media for mobile systems. Flash memory has significant advantages over magnetic hard disks such as having lower power dissipation and smaller physical sizes. In addition to replacing hard drives, flash memory has been replacing floppy disks because flash memory provides higher storage capacity and faster access speeds than floppy disks. Examples of mass-storage systems that utilize flash memory as its storage media include Universal Serial Bus (USB) Drive, Secure Digitalcard, MultiMediaCard, Memory Stick, Compact Flash Card, ExpressCard, Flash Memory Hard Drive, etc. Accordingly, because of the compatibility of flash memory with mobile systems, the flash memory trend has been growing.

Flash memory, however, has inherent limitations. First, flash memory sectors that have been already programmed must be erased before being reprogrammed. Consequently, write operations of flash memory are slow due to their erase-before-write nature. Second, the sectors of flash memory have a limited life span; i.e., they can be erased only a limited number of times before failure. For example, one million is a typical maximum number of erases for a sector of NAND flash memory. Accordingly, because of this erase-before-write nature, ongoing erasing will eventually bring a flash memory sector to failure over time. Typically, the life span of a flash memory device is specified by the manufacture.

A flash memory device may initially have bad blocks, e.g., 10%, coming of off the production line. Also, a flash memory device may have initially functional blocks, which later become bad blocks in time before the end of the manufacture-specified life span. These bad blocks manifest during write or erase operations. Unfortunately, increasing occurrences of bad blocks dramatically decreases the performance of the flash memory system.

To deal with bad blocks, flash memory systems typically search the arrays of multiple flash memory devices for available spare blocks. Valid data in a bad block or data to be written to a bad block needs to be reassigned and relocated to one or more available good (i.e., functional) spare blocks. The data is placed in an external buffer while spare blocks with available good sectors are being found. The data is then written to those blocks when a sufficient number of spare blocks are found.

A problem with this solution is that if one or more flash memory devices are at capacity, the flash memory system must continue searching other devices until a sufficient number of spare blocks with good sectors are found. This can cause congestion at the external buffer. This adversely affects the overall performance of the flash memory system.

The number of available blocks in a flash memory device become fewer as flash memory devices fill to capacity of as the number of obsolete blocks increases. An “obsolete block” is one with “obsolete sectors,” which are sectors that have been programmed with data but the data has been subsequently updated. When the data is updated, the obsolete data remains in the obsolete sector and the updated data is written to new sectors, which become “valid sectors” having “valid data.” Valid data can include updated data as well as data that has not been updated. Accordingly, the number of obsolete blocks grows as files are modified or deleted.

Obsolete blocks are recycled in an operation commonly referred to as a “garbage collection” operation. During a garbage collection operation, obsolete blocks are erased so that they are available for future write operations. An obsolete block can contain both obsolete data and valid data. The valid data needs to be copied to an available block before the obsolete block can be erased. During a garbage collection operation while a search for available blocks is being conducted, valid data in an obsolete block is copied to an external buffer while multiple flash memory devices are globally searched to locate available spare blocks. Once found, the valid data in the external buffer can be copied to the available spare blocks. A problem with this operation is the congestion can occur at the external buffer, which adversely affects the performance of the flash memory system.

Another solution for dealing with bad blocks involves replacing blocks in an operation commonly referred to as “wear leveling.” In such an operation, valid data is transferred from one block to another to distribute the data more evenly. However, this operation involves an external buffer and a search for available blocks among multiple devices. As stated above, if congestion occurs at the external buffer, the performance of the flash memory system is adversely affected.

Generally, there is not a good solution to these problems today in that the known solutions do not address the added processing time required to search multiple flash memory devices for available spare blocks. The known solutions also do not address the issue of potential congestion at the external buffer that can occur during such a search. Unfortunately, such limitations adversely affect the management of bad blocks, garbage collection, and wear leveling.

Accordingly, what is needed is an improved system and method for managing blocks in flash memory. The system and method should address the processing time required to search for available blocks when dealing with bad blocks, garbage collection, and wear leveling. The system and method should also be simple, cost effective and capable of being easily adapted to existing technology. The present invention addresses such a need.

### SUMMARY OF THE INVENTION

A flash memory controller is disclosed. The flash memory controller comprises a processor for performing at least one operation and arbitration logic coupled to the processor. Data from the arbitration logic allows the processor to perform the at least one operation for a flash memory device. In one aspect of the present invention, the processor utilizes data from the arbitration logic to direct a search for available blocks to the particular flash memory device. In another aspect of the present invention, the processor utilizes an internal buffer within the flash memory device to store valid data during the search before the valid data is relocated.

As a result, the search time for available blocks is greatly shortened and the need for an external buffer is eliminated. Consequently, the speed at which block management operations are performed is significantly increased.

### BRIEF DESCRIPTION OF THE DRAWINGS

FIG. 1 is a block diagram of a conventional flash memory system coupled with a host system.

FIG. 2 is a block diagram of a flash memory system in accordance with the present invention.

FIG. 3 is a block diagram showing in more detail the interface between the arbitration logic, the register file, and the mapping table of the flash memory system of FIG. 2 in accordance with the present invention.

FIG. 4 is a block diagram showing a conventional block management operation.

FIG. 5 is a block diagram showing a block management operation in accordance with the present invention.

FIG. 6 is a high-level flow chart showing a method for managing bad blocks in flash memory in accordance with the present invention.

FIG. 7 is a block diagram showing in more detail a flash memory device, which can be used to implement a flash memory device of FIGS. 3 and 5 in accordance with the present invention.

FIG. 8 is a flow chart showing a method for accessing data in accordance with the present invention.

FIG. 9 is a flow chart showing a method for replacing bad blocks in accordance with the present invention.

FIG. 10 is a flow chart showing a method for a garbage collection operation in accordance with the present invention.

FIG. 11 is a flow chart showing a method for a wear leveling operation in accordance with the present invention.

### DETAILED DESCRIPTION

### DEFINITIONS

The following terms are defined in accordance with the present invention.

Sector: A basic structure in NAND flash memory devices. A sector can have 512 bytes (small block format), or 2112 bytes (large block format) as a data field, and 16 bytes or 64 bytes as a spare field. A sector is commonly referred to as a page. A page or partial page is a programming unit.

Block: A group of sectors. A block can have 16, 32, 64, or more sectors, depending on the specific application. A block is also used as an erasing unit.

Cluster: A data communication unit for a host operating system. A cluster is a storage unit, which is typically a group of 2 or more sectors.

A file allocation table (FAT): A FAT is based on a cluster unit and provides a table of pointers to cluster addresses.

Erase-before-write: A required that programmed sectors of flash memory must be erased before being reprogrammed.

Bad Block: A block that is not functional. A block can be a bad block initially when produced or can become a bad block later while in the field. A bad blocks can manifest during write or erase operations.

Block replacement: An operation involving replacing a bad block with a good block. When a bad block occurs, the valid sectors in that block are relocated (i.e., copied) to good blocks. This operation is referred to as a bad block replacement operation.

Garbage collection: An operation involving recycling obsolete blocks for future programming (i.e., write operations). A block becomes an obsolete block when data stored in the block is updated.

Wear leveling: An operation involving distributing valid data among blocks to prolong the life of the sectors in a flash memory system.

Spare blocks: Reserve blocks in flash memory. Spare blocks are utilized during bad block replacement operations.

Global flash memory system: A system where firmware treats all flash memory devices array as one unit. The firmware recognizes an continuous range of logical block addresses and does not recognize flash memory device boundaries or capacity.

Distributed flash memory system: A system where firmware treats each flash memory device as separate individual memory units. Spare blocks are reserves within each flash memory device. The arrangement can fully utilize flash memory copy-back feature to improve data transfer among sectors.

Scalability: As the number of flash memory devices increase, conventional flash memory systems rely on a global flash memory system to optimize the flash memory operations.

Intra-chip operation: An operation that occurs within the boundaries of a single flash memory device.

Inter-chip operation: An operation that occurs among different flash memory devices. An external buffer is required to complete operations.

### PRESENT INVENTION

The present invention relates to memory systems, and more particularly to a system and method for managing blocks in flash memory. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention for managing blocks in flash memory are disclosed. The system and method provide a flash memory controller comprising a processor for performing operations in a flash memory system. Such operations include block management operations, which include the handling of bad blocks, the recycling of obsolete blocks, and wear leveling. The processor can utilize data from arbitration logic to perform each of these operations for particular flash memory devices of a flash memory system. Since each of these operations occurs within a particular flash memory device, the processor can utilize data from the arbitration logic to direct a search for available blocks to the particular flash memory device. Also, the processor can utilize an internal buffer within the flash memory device to store valid data during the search before the valid data is relocated. As a result, the search time for available blocks is greatly shortened and the need for an external buffer is eliminated. Consequently, the speed at which block management operations are performed is significantly increased. To more particularly describe the features of the present invention, refer now to the following description in conjunction with the accompanying figures.

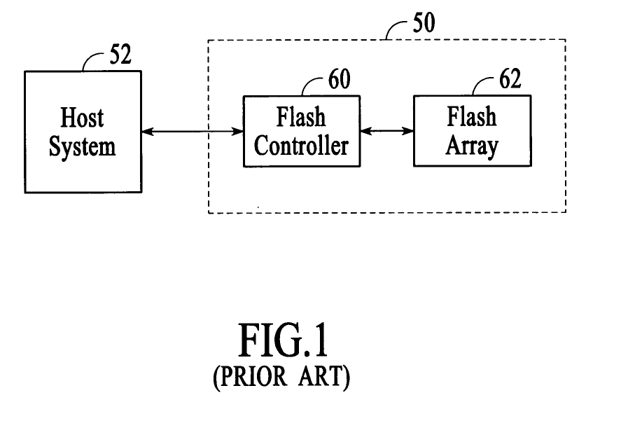

FIG. 1 is a block diagram of a conventional flash memory system 50 coupled with a host system 52. The flash memory system 50 includes a flash memory controller 60 and a flash memory 62. In operation, the host system 52 sends write and read requests to the flash memory controller 60. Data is written to and read from the flash memory 62. The host system 50 generally provides resources to process write and read transactions, and erase operations via the flash memory controller 60.

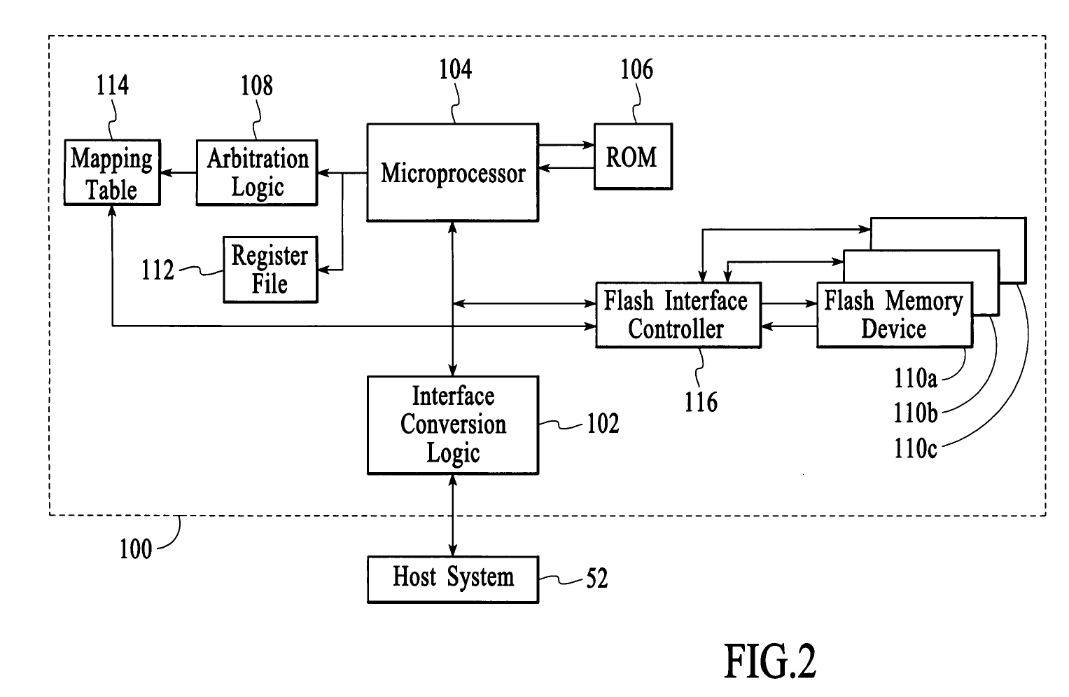

FIG. 2 is a block diagram of a flash memory system 100 in accordance with the present invention. The flash memory system 100 interfaces with a host system 52 via interface conversion logic 102, which handles data and timing alignment for a microprocessor 104. The interface conversion logic 102 can be compatible with various formats such as Universal Serial Bus (USB), Peripheral Component Interconnect (PCI), Compact Flash (CF), Secure Digital (SD), etc., depending on the specific application. The host system can be a personal computer (PC), digital camera, MP3 player, etc.

The microprocessor 104 executes read, write, and erase operations, block management operations, as well as other house-keeping operations in the flash memory system 100. The block management operations involve copy and erase operations, which are performed in the background, i.e., hidden from the host system 52. A read-only memory (ROM) 106 stores code for executing the operations executed by the microprocessor 104.

The microprocessor 104 utilizes arbitration logic 106 to perform block management operations separately for each flash memory device 110a, 110b, and 110c of the flash memory system 100. The arbitration logic can be implemented using hardware logic or field programmable gate arrays (FPGAs).

A register file 112 assigns logical block addresses (LBAs) to the flash memory devices 110a-c. A mapping table 114 provides an index of information associated with the flash memory devices 110a-c. Such information includes, for example, LBAs, device numbers, PBAs, valid bits, and obsolete bits. A flash interface controller 116 interfaces with the flash memory 110a-c to carry out commands from the processor 104. Such commands include read, write, and erase operations.

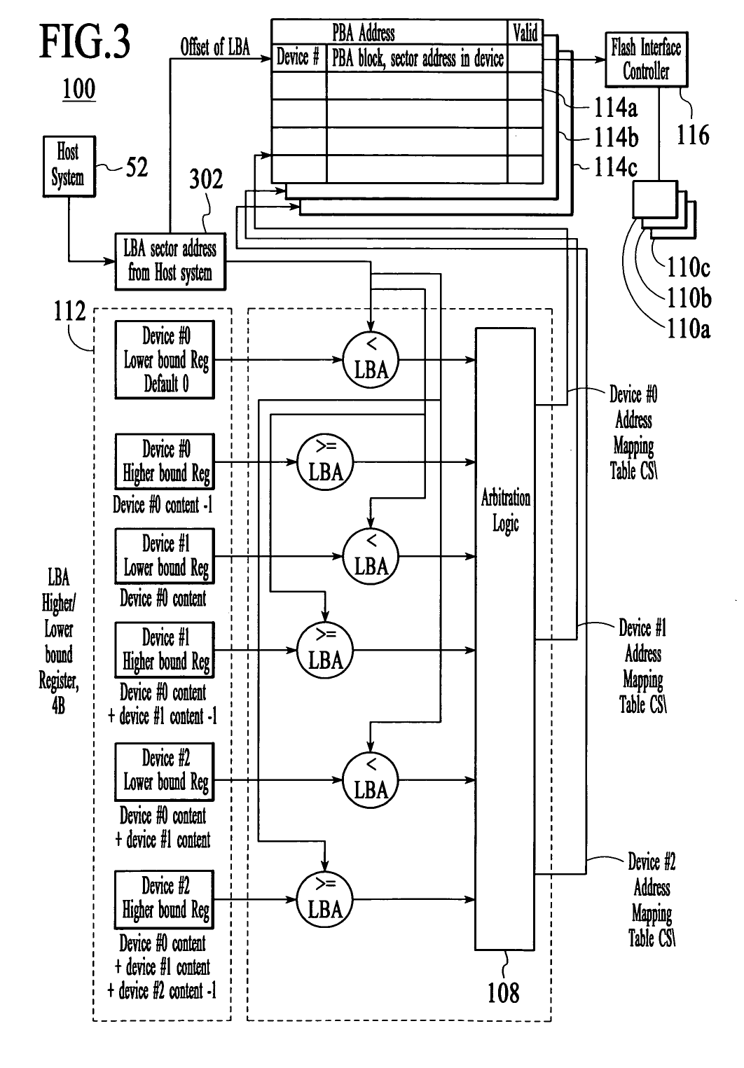

FIG. 3 is a block diagram showing in more detail the interface between the arbitration logic 108, the register file 112, and the mapping table 114 of the flash memory system 100 of FIG. 2 in accordance with the present invention. The host system 52 typically sends an LBA 302 to the flash memory system 100. The LBA 302 includes a sector-offset address. The LBA 302 is a sector-addressing unit.

The register file 112 associates the LBA with a particular device number. LBAs within a certain range are associated with a particular device number. The arbitration logic 108 sends the LBA and the associated device number to the mapping table 114. The address capacity of each flash memory device is pre-programmed into corresponding registers to provide LBA assignments. Once the physical block address (PBAs) is identified by the arbitration logic 108 for each particular flash memory device, all read/write operations are performed internally within that device.

The mapping table 114 translates the LBA to a PBA and outputs the device number and PBA to the flash interface controller 116. The mapping table 114 in an index that comprises one or more look-up tables (LUTs), which can be implemented using volatile random access memory (RAM), such as synchronous RAM (SRAM). In a specific embodiment, there is one mapping table 114a, 114b, and 114c for every flash memory device 110a, 110b, and 110c, respectively. The mapping table 114 translates the LBA into a particular PBA for the device number provided by the arbitration logic 108. The mapping table also provides valid bit values. The valid bit values are reset to zero during power up.

During an initialization process, a maximum number of erase operations for a particular sector is programmed into the LBA 112 for address arbitration. The flash interface controller 116 generates a sequence of timing signals to a particular flash memory devise 110 to carry out write and erase operations associated with block management of the particular flash memory device 110.

Because each register of the flash memory device 110 can be independently programmed, the individual flash memory devices 110a-e constituting the flash memory can have different capacities. Mixing brands of flash memory devices is also possible. This flexibility reduces the overall manufacturing costs. The page size, which is the total number of bytes per physical sector, should be the same (e.g., 512 bytes or 2112 bytes) with each of the flash memory devices 110a-e.

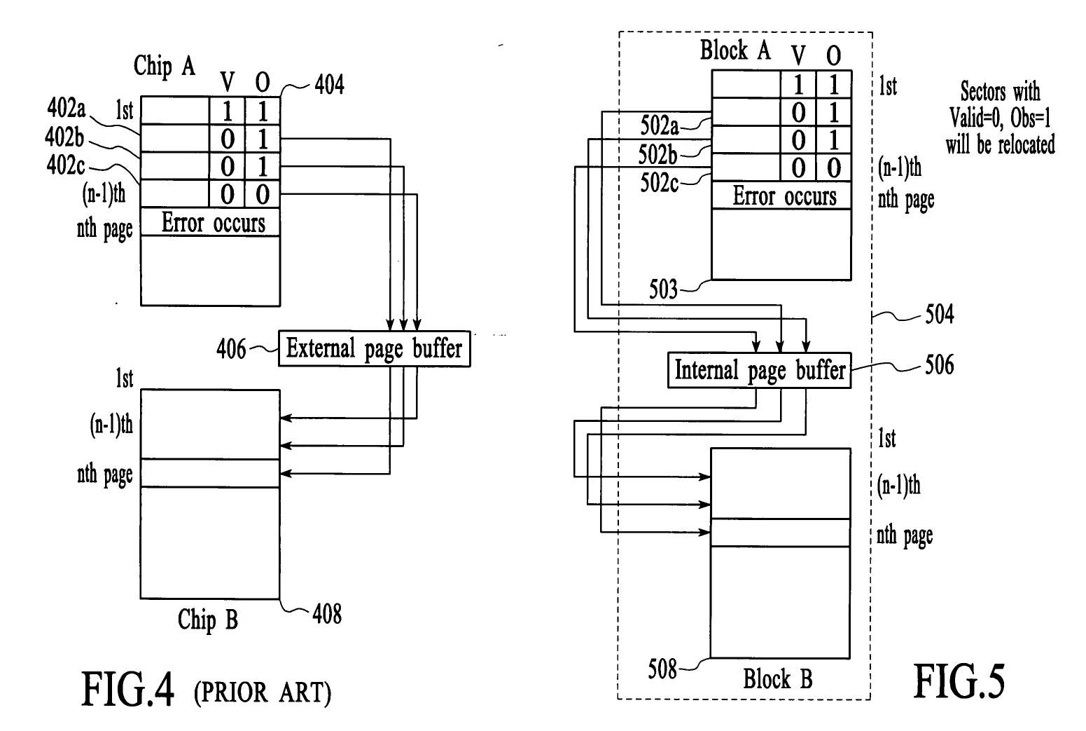

FIG. 4 is a block diagram showing a conventional block management operation. As is shown, valid data stored in blocks 402a, 402b, and 402c of a one flash memory device 404. During a block management operation (e.g., bad block replacement, obsolete block recycling, wear leveling) the valid data stored in blocks 402a, 402b, and 402c are relocated if the blocks 402a, 402b, and 402c become bad, obsolete, or need to undergo wear leveling. Block management operations can be generally referred to as house-keeping operations. They occur in the background to facilitate write operations. In this example, the block management operation is a bad block operation involving bad block replacement.

As is shown, the valid data is relocated (i.e., copied) to an external buffer 406. A search for good (i.e., functional) blocks in other flash memory devices is then conducted. Conventional flash memory systems treat multiple flash memory devices as a single global unit. Accordingly, the blocks of all of the flash memory devices are arranged in a global address scheme such that all of the flash memory devices are searched. When good blocks are found in another flash memory device 408, the valid data can then be copied to the good blocks of the flash memory device 408. The external buffer 406 is utilized in a similar fashion during other block management operations.

FIG. 5 is a block diagram showing a block management operation in accordance with the present invention. As is shown, valid data is stored in blocks 502a, 502b, and 502c of one block 503 in a flash memory device 504. During a block management operation, the valid data stored in blocks 502a, 502b, and 502c are relocated.

In accordance with the present invention, block management operations are performed separately for each flash memory device and are intra-chip operations, i.e., performed internally within the boundaries of each flash memory device. In other words, during block management operations, valid data is relocated to optimal locations within each flash memory device. This improves the performance compared to that of conventional block management operations, which relocate valid data to different flash memory devices. A problem with the conventional block management operations is that they require a broader search for good sectors where multiple flash memory devices are searched. Also, conventional block management operations require the use of an external buffer. Transferring valid data from one device to an external buffer and then to another flash memory device adds time to the overall operation. The present invention avoids this problem by performing block management operations separately for each flash memory device and are performed internally within each flash memory device.

Another benefit of the present invention is that multiple block management operations can occur simultaneously within different flash memory devices to further increase the performance of the flash memory system. This also enables different flash memory devices to be erased and programmed simultaneously. Such an increase in system parallelism significantly increases the performance of the flash memory system.

In this example, the block management operation is a bad block operation involving bad block replacement. The valid data stored in blocks 502a, 502b, and 502c are relocated if the blocks 502a, 502b, and 502c become bad. In this specific embodiment, the valid data is copied to an internal buffer 506. The internal buffer 506 is an available properly functioning sector within the flash memory device 504. In a specific embodiment, spare blocks of sectors are reserved to provide the internal buffer 506 in each flash memory device. This reduces the need for external search, i.e., searches beyond the boundaries of a flash memory device. A search for good blocks in another portion of the same flash memory device 504 is then conducted. The blocks of all of the flash memory devices are arranged in a distributed address scheme, as described in FIG. 3, and searches are directed to the boundaries of a single flash memory device.

When good blocks are found, the valid data can then be copied to one or more of the good blocks. In either case, the search time is greatly reduced because it is an intra-chip search as compared to the conventional inter-chip search as shown in FIG. 4. Also, because the bad block operation occurs within a single flash memory device 504, the time to relocate valid data is greatly reduced. In accordance with the present invention, this eliminates the need for an external buffer. Accordingly, the relocation time is greatly reduced because the valid data need not be transferred external to the flash memory device 504.

The internal buffer 506 can be utilized in a similar fashion during other block management operations in accordance with the present invention. Alternatively, during a block management operation, the valid data can be relocated directly to good sectors without having to be first stored in the internal buffer 506.

In accordance with the present invention, each flash memory device functions as an individual addressing unit and block management operations occur within the boundaries of each flash memory device. Accordingly, another benefit of the present invention is that flash memory devices of different capacities can be used within the same flash memory system.

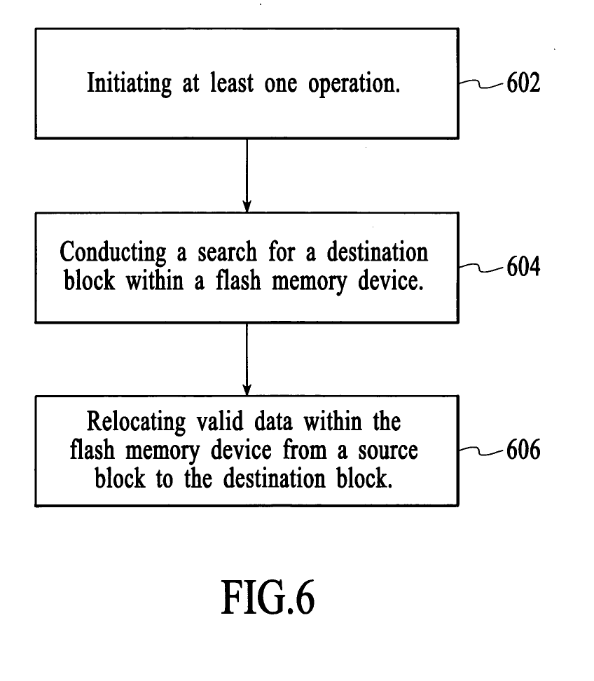

FIG. 6 is a high-level flow chart showing a method for managing blocks in flash memory in accordance with the present invention. First, at least one operation is initiated in a flash memory system comprising a plurality of flash memory devices, in a step 602. In this specific embodiment, the operation is a block management operation. Next, a search for a destination block within a flash memory device is conducted, in a step 604. Next, valid data within the flash memory device is relocated from a source block to the destination block, in a step 606. Accordingly, block management operations are performed for particular flash memory devices of the plurality of flash memory devices. When multiple block management operations are performed for multiple flash memory devices, a separate block management operation is performed for each particular flash memory device. This allows for separate and simultaneous block management operations for each particular flash memory device.

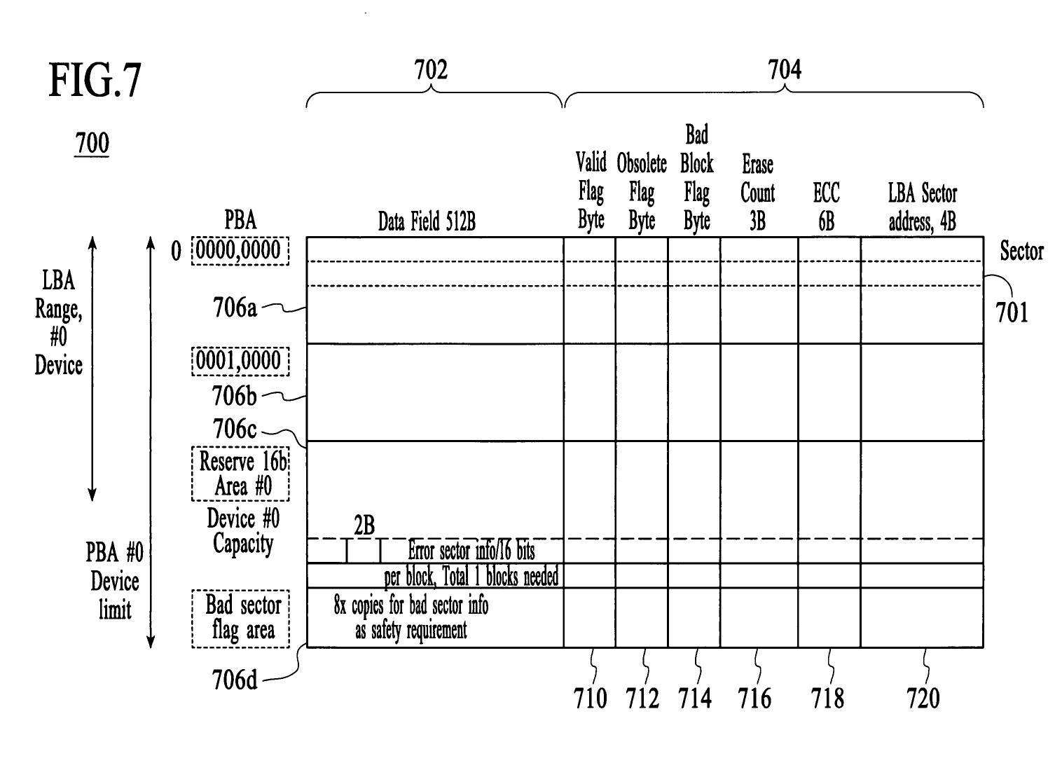

FIG. 7 is a block diagram showing in more detail a flash memory device 700, which can be used to implement a flash memory device of FIGS. 3 and 5 in accordance with the present invention. The flash memory device 700 has a range of LBAs assigned to it. This range is based on arbitration logic as described in FIG. 3. The PBAs for the flash memory device 700 begins at zero and increases to a maximum capacity for the flash memory device 700. Typically, the maximum capacity of a flash memory device is 4,096 blocks, and can be higher with 16 or 32 sectors per block.

In this specific embodiment, a sector (commonly referred to as a page) 701 consists of 528 bytes. The flash memory device 700 has a data structure that comprises a data field 702 and a spare field 704 for each PBA 706a, 706b, 706c, and 706d. Each field holds a certain number of bytes and the specific number will depend on the application. For example, a data field may have 512 bytes, 2,112, or more bytes, and the spare field can have 16, 64, or more bytes.

The data field 702 stores raw data and the spare field 704 stores information related to memory management. The spare field 704 includes a valid sector field 710, an obsolete sector field 712, a bad block indicator field 714, an erase count field 716, an error correction code (ECC) field 718, and an LBA sector address field 720. The valid sector field 710 indicates whether the data in the sector is valid for reading. The obsolete sector field 712 indicates whether the data in the sector is obsolete. The obsolete flag can be modified by a subsequent write or erase operation. The bad block indicator field 704 indicates bad blocks. In the bad block indicator field 704, a 0 bit indicates that the block is damaged. A bad block occurs when an attempt to write to a particular sector or to erase a particular block fails. In a specific embodiment, the bad block indicator is set by the manufacture. The firmware of the flash memory system scans the first sector of each block to determine the accessibility of data. Information associated with the scan is then stored in the last block of each flash memory device.

In this specific embodiment, 2 bytes for each block are used to record bad sector information. For higher reliability, 8 copies of the bad block information are stored to avoid bad block incidents during the recording of flags. These 8 blocks are stored in the last block location of each flash memory device for faster accessibility. A special bad sector indicator field 714 is located at the last block to be more easily read by the firmware of the flash memory system, especially where there is one bit per sector.

The erase count field 716 records the number of erases of a block. The erase count field 716 stores 3 bytes and can record 16 million block erase operations. The ECC field 718, which stores 6 ECC bytes, provides data consistency. EEC is a sophisticated method that is utilized for error detection and correction. The LBA sector field 720 is dedicated for power backup or system re-entry usage. Because the mapping table of the flash memory system is stored in volatile memory and thus does not preserve the valid sector information during power loss, the LBA sector address field 720 is used to reconstruct the mapping table during system initialization and power failure. The LBA sector address field 720 records previous write operations as well as valid sector and obsolete sector information to reconstruct the mapping table. The firmware of the flash memory system can repair the dangling clusters when a new data structure is setup. This is accomplished by checking a FAT table stored in the flash array of the flash memory device.

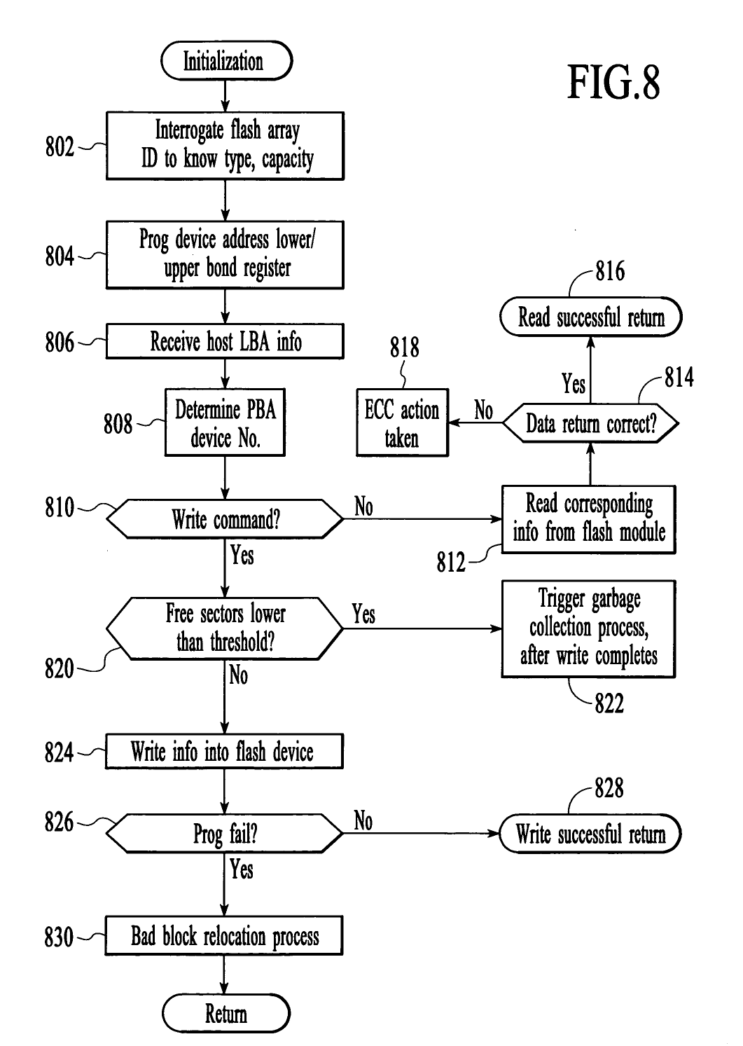

FIG. 8 is a flow chart showing a method for accessing data in accordance with the present invention. After initialization of the flash memory system, a flash array identification (ID) is interrogated to determine the capacity of the flash array of a flash memory device, in a step 802. Also, the PBAs of each flash memory device are scanned to determine existing bad sectors, in the step 802. This determination can be accomplished by reading the bad block indicator field. If the number of bad blocks exceeds what is required by the host system, the sectors of the flash memory device are re-configured to provide a sufficient number of blocks.

A range of LBAs is programmed into the register file of the flash memory controller, in a step 804. In a given flash memory device, the range of PBAs is larger than the range of LBAs because space in the flash memory device is reserved bad block replacement. For example, 10% of a flash array is a reasonable number of reserved space.

Next, an LBA sector address, data, and a command is received from a host system, in a step 806. A cluster data buffering and post-write cache scheme is utilized to enhance the performance of the flash memory system. Next, a flash memory device number and a PBA are determined by the mapping table, in a step 808. Next, a command from the host system is analyzed, in a step 810. If the command is a read command, a read operation is performed, in a step 812. Then, the data from the read operation is checked, in a step 814. The data is checked using the bytes in the ECC field. If the data is correct, the data is returned to the host system, in a step 816. If the data from the read operation is not correct, an EEC operation is performed to correct the data, in a step 818.

If the command is determined to be a write command in the step 810, a write operation is performed. A write operation significantly longer than a read operation. For example, a write operation can 20 times longer than a read operation. Free (i.e., available) sector threshold levels are check, in a step 820. If the amount of free block space is lower then the free sector threshold value, blocks are recycled in a garbage collection operation, in a step 822.

If the amount of free block space is not lower then the free sector threshold value, data is written in the flash memory device, in a step 824. Upon completion of the write operation, it is determined whether the write operation succeeded or failed, in a step 826. If the write operation was successful, the write operation terminates, in a step 828. If the write operation failed, this means that the block is bad, and a bad block operation is then performed, in a step 830.

Generally, when a block is bad, the data in the sector is not reliable. A block is determined to be a bad block even if only one sector in that block is bad. To ensure data reliability, data will no longer be assigned the bad block and is reassigned to a good block. Accordingly, valid data in the sectors of the bad block are transferred to the good block for further reference. This operation is referred to as called block replacement. A copy-back command is issued internal this device to reduce the transaction time.

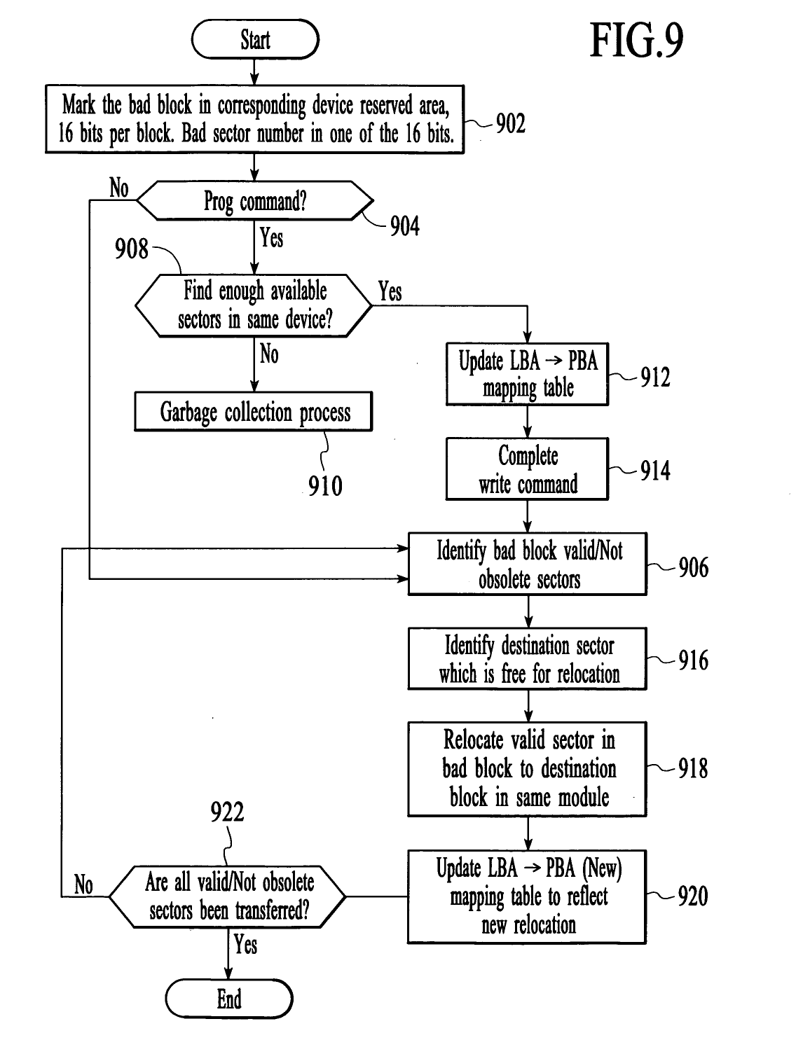

FIG. 9 is a flow chart showing a method for replacing bad blocks in accordance with the present invention. The bad sector location of the bad block is recorded in a reserved area in the last 2 blocks of the flash memory device, in a step 902. In a specific embodiment, there are 16 sectors per block. There are 16 bits where each bit is associated with one of the 16 sectors. The bits are used to indicate the failed sectors. Accordingly, if any one of the bits are 0 indicating that the sector is bad, the entire block is determined to be bad. Programming the bit location is accomplished by first reading out the whole sector, then write into it the original plus bit values. The firmware ensures that 4 copies are made to ensure assure correctness. All 8 blocks are in the last space of each device. Each bit is set once during the lifetime of the sector to indicate the bad sector location.

Next, it is determined whether there is a write command, in a step 904. If an erase operation fails and there is no write command, the valid data in the sectors in the bad block are identified, in a step 906. If there is a write command in the step 904, a search for available sectors with the same device is executed, in a step 908. If there is not a sufficient number of available sectors, a garbage collection operation is executed, in a step 910, until there is a sufficient number of available sectors. If there is a sufficient number of available sectors, the LBAs of the mapping table are updated, in a step 912. Next, the write operation is complete, in a step 914. After the write operation is completed, the valid data in the sectors of the bad block are identified, as in the step 906. This process is carried out whenever a write or erase operation fails.

Next, a destination sector of the good block to which the valid data of the bad block has been reassigned is identified, in a step 916. Next, the valid data is relocated (i.e., copied) to the destination sector, in a step 918. During the step 918, a copy-back action is taken within the flash memory device to avoid external traffic and to enhance the performance of the flash memory system. Next, the mapping table in the flash memory controller is updated to reflect the change for future access of the data, in a step 920. Next, it is determined if all of the valid data from the bad block has been transferred to the good block, in a step 922. In not, the operation loops back to the step 906. If all the valid data have been transferred, the bad block replacement operation terminates.

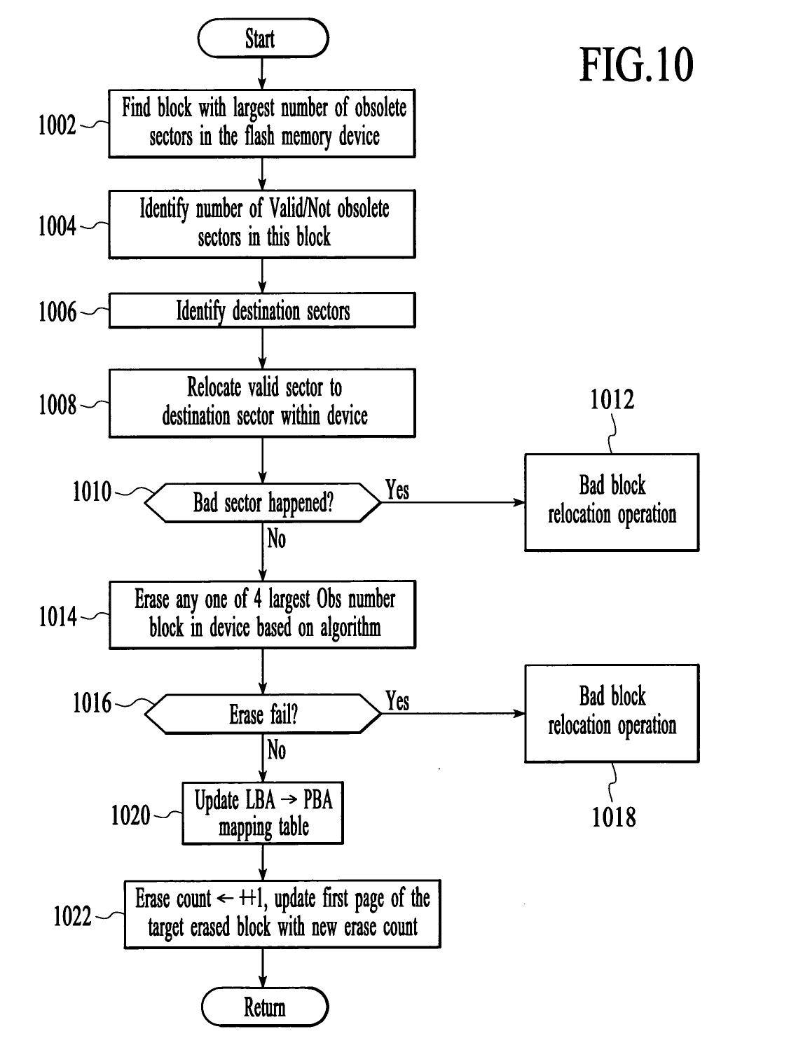

FIG. 10 is a flow chart showing a method for a garbage collection operation in accordance with the present invention. The garbage collection operation is an intra-chip operation, i.e., within the boundary of each flash memory device. Accordingly, multiple garbage collection operations can occur simultaneously within different flash memory devices. First, a search occurs within a flash memory device to locate the block with the largest number of obsolete sectors, in a step 1002. Specifically, the firmware scans through the obsolete sector fields to determine the number of obsolete sectors in each block. The results of the search is stored in a register. The registers indicate the blocks with the largest number of obsolete sectors. For example, there can be 4 registers to indicate the 4 blocks with the largest number of obsolete sectors. The results are also stored with LBA values to update address mapping tables. In the mean time a different set of registers are also set to record the 4 largest free sectors per block in this device. Since the purpose is erasing one block, these four register set can found best match for source and destination block selection.

Next, the number of valid sectors are identified, in a step 1004. Next, addresses of valid sectors are identified, in a step 1006. The valid sectors associated with these addresses are referred to as destination sectors. Next, a copy-back operation is executed to copy the valid data from the obsolete block to the destination sectors, in a step 1008. During the copy-back operation the valid data can be temporarily stored in an internal buffer.

Next, it is determined whether any bad sectors has manifested during the garbage collection operation, in a step 1010. If a bad sector has manifested, a bad block relocation operation is executed, in a step 1012. If no bad sector has manifested, any one of the blocks having the largest number of obsolete sectors is erased and the bits of the block are changed to 1, in a step 1014. Next, it is determined if the erase operation has failed, in a step 1016. If the erase operation has failed, a bad block relocation operation is executed, as in the step 1018. If the erase operation has not failed, mapping table is updated to reflect the modification for future write operations, in a step 1020. Next, the erase count for the erased block is incremented in the erase count field, in a step 1022.

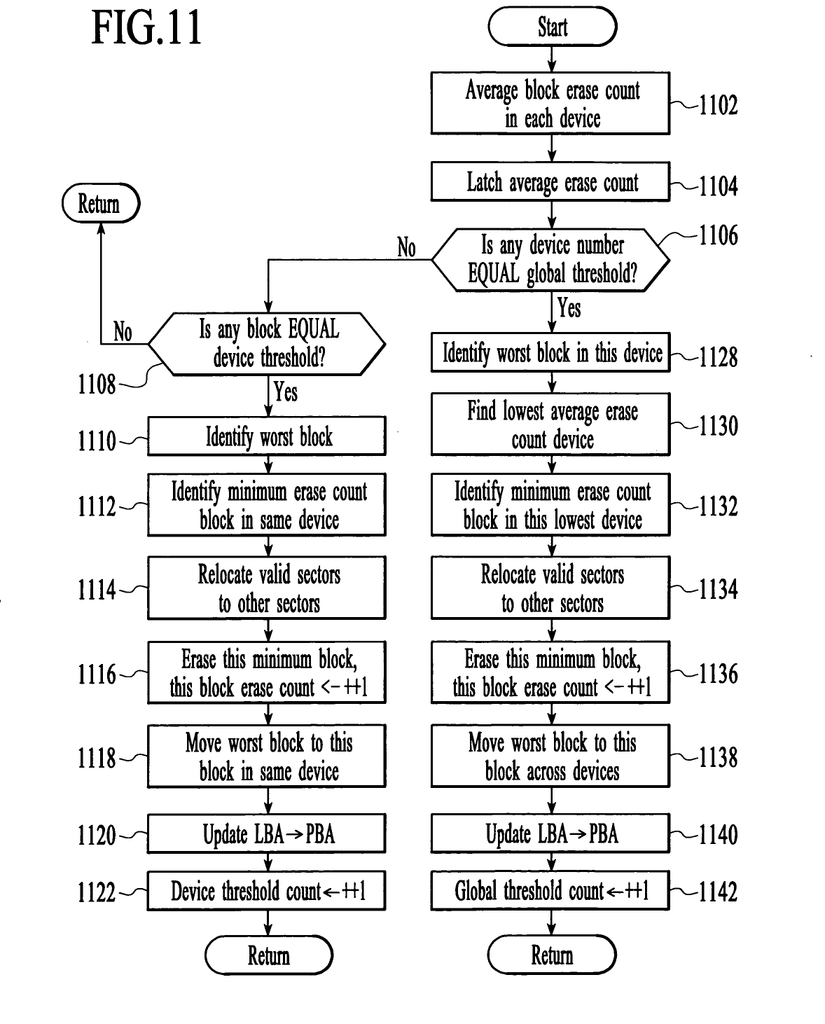

FIG. 11 is a flow chart showing a method for a wear leveling operation in accordance with the present invention. The wear leveling operation occurs in the background while there is no data-transfer request from the host system. Pending data-transfer request from the host system may occur while the wear leveling operation is in process. The wear leveling operation generally relocates valid data from blocks with low erase counts to blocks with high erase counts. The blocks with low erase counts are then erased and their erase counts are incremented. This evens out the erase counts of blocks by bring the blocks with the highest erased counts closer to the average device erase count. This delays any give block from reaching its maximum erase count.

First, the erase count in the erase count field for every block is read by the firmware and the average erase count value is determined for each flash memory device, in a step 1102. The average erase count values are then latched, i.e., saved, in a register for future use, in a step 1104. In a specific embodiment, two registers are designated to save erase count values for each flash memory device. One register stores the average erase count for a particular flash memory device, referred to as a device threshold count. The other register stores an average erase count value for all of the flash memory devices, referred to as a global threshold count. For example, a device threshold count can be 5,000, and the global threshold count can be 20,000. These two values are also pre-programmed as part of the initialization process of the flash memory system.

Next, it is determined whether any flash memory device has a device threshold count is greater than the global threshold count, in a step 1106. If not, it is determined whether any block in that device has an erase count greater than the device threshold count, in a step 1108. If not, the wear leveling operation terminates. If any block erase count is greater than its device threshold count, the block with the highest erase count is identified, in a step 1110. Next, the block with the lowest erase count in that device is identified, in a step 1112. Next, valid data in the block with the lowest erase count is relocated to another block, in a step 1114. Next, the block with the lowest erase count is erased and its erase count is incremented, in a step 1116. Next, valid data in the block with the highest erase count is relocated to the block with the lowest erase count, in a step 1118. Next, the mapping table is updated, in a step 1120. Next, the device threshold count is incremented, in a step 1122. The wear leveling operation then ends.

Involving multiple flash memory devices in a block management operation of one flash memory device, where valid data is relocated externally from one flash memory device to another. The substantially enhances the overall performance of the flash memory device system. In another specific embodiment, if a particular flash memory device undergoing block management operation has a high erase count compared to other flash memory device, relocating valid data externally from one flash memory device to another is performed to achieve balance among the different flash memory devices. External relocation, however, occurs in addition to internal relocation in accordance with the present invention.

Referring back to the step 1116, if there is a flash memory device having a device threshold count that is greater than the global threshold count, the block with the highest erase count in that device is identified, in a step 1128. Next, the flash memory device with the lowest average erase count is identified, in a step 1130. Next, the block with the lowest erase count in that device is identified, in a step 1132. Next, valid data in the block with the lowest erase count is relocated to another block, in a step 1134. Next, the block with the lowest erase count is erased and its erase count is incremented, in a step 1136. Next, valid data in the block with the highest erase count is relocated to the block with the lowest erase count, in a step 1138 In a specific embodiment, the valid data is moved to another flash memory device. Next, the mapping table is updated, in a step 1140. Next, the device threshold count is incremented, in a step 1142. The wear leveling operation then ends.

The flash memory controller of the present invention can perform multiple-block data access. The conventional flash memory device has a 512-byte page register built-in. The data write to the flash memory device has to write to the page register first and then to a flash memory cell. The conventional flash memory controller, as well as its built-in firmware, controls the flash memory access cycles. The conventional flash memory controller transfers one single block (512 bytes) of data to the page register of the flash memory device at a time. No other access to the flash memory is allowed once the 512 bytes page register is filled. Consequently, the conventional flash memory controller, which uses the single-block data access methodology, limits the performance of flash memory devices.

In accordance with the present invention, the flash memory controller utilizes a 2K or larger size page register. The flash memory controller of the present invention functions as a multiple-block access controller by sending multiple blocks of data simultaneously to a flash memory to fill up the page register. This significantly improves the performance of the data transfer. Compared to the conventional single-block data-transfer controller, which transfers a single block at a time, the data transfer performance using the flash memory controller of the present invention is significantly improved.

The flash memory controller of the present invention can also provide dual channel processing to improve performance of the flash memory system. Dual channeling provides a second channel, or “freeway,” for executing transactions between the flash memory controller and the flash memory device. A conventional flash memory controller uses a single memory bus such that one or more flash memory devices attached to it. However, the conventional architecture limits the performance of the conventional flash memory controller.

In accordance with the present invention, at least two sets of memory buses are utilized. Each set of memory buses is coupled to separate flash memory devices. The memory controller can access flash memory devices together or separately. As a result, transactions can be executed twice as fast utilizing dual channel processing. Furthermore, each memory bus can also be further expanded to multiple sets of memory buses.

The flash memory controller of the present invention can also interleave operations. A conventional flash memory controller uses a single set of memory buses such that one or more flash memory devices are attached to it. However, the conventional flash memory controller can only access the flash memory devices one at a time. Accordingly, the conventional architecture limits the performance of the conventional flash memory controller.

In accordance with the present invention, at least one or two extra sets of memory control signals (such as separate Chip Enable and Busy signals) are utilized. Furthermore, a shared memory bus having at least two banks of flash memory devices are attached to the shared memory bus. The flash memory controller of the present invention can access one bank of flash memory devices while the other bank is busy reading or writing. Accordingly, the flash memory controller of the present invention fully utilizes the shared memory bus and thus significantly increase the performance. Furthermore, the number of pins of the flash memory controller are reduced by sharing memory IO and control signals. This minimizes the cost to make flash memory devices.

In accordance with the present invention, one in the art can integrate functions of multiple block access, multiple bank interleaving, and multiple channel operations together in a memory access cycle of a single chip to achieve maximum performance.

In accordance with the present invention, the flash memory controller can be applied to USB as well as ExpressCard plug and receptacle systems. Also, the flash memory controller can be applied to other embodiments involving multi-mode USB, Secure Digital (SD), MultiMediaCard (MMC), Memory Stick (MS), and Compact Flash (CF) plug and receptacle systems.

According to the system and method disclosed herein, the present invention provides numerous benefits. For example, it enables flash memory controllers to greatly shortens the search time for available blocks during block management operations. Also, it enables flash memory controllers to eliminate the need for an external buffer. Furthermore, the flash memory controller provides multiple block data access, dual channel processing, and multiple bank interleaving. Consequently, the speed at which block management operations are performed is significantly increased.

A system and method in accordance with the present invention for managing blocks in flash memory are disclosed. The system and method provide a flash memory controller comprising a processor for performing operations in a flash memory system. Such operations include block management operations, which include the handling of bad blocks, the recycling of obsolete blocks, and wear leveling. The processor can utilize data from arbitration logic to perform each of these operations for particular flash memory devices of a flash memory system. Since each of these operations occurs within a particular flash memory device, the processor can utilize data from the arbitration logic to direct a search for available blocks to the particular flash memory device. Also, the processor can utilize an internal buffer within the flash memory device to store valid data during the search before the valid data is relocated. As a result, the search time for available blocks is greatly shortened and the need for an external buffer is eliminated. Consequently, the speed at which block management operations are performed is significantly increased.

Although the present invention has been described in accordance with the embodiments shown, one of ordinary skill in the art will readily recognize that there could be variations to the embodiments and those variations would be within the spirit and scope of the present invention. Embodiments of the present invention can be implemented using hardware, software, a computer readable medium containing program instructions, or combination thereof. Accordingly, many modifications may be made by one of ordinary skill in the art without departing from the spirit and scope of the appended claims.

1. A flash memory controller comprising:
a processor for performing at least one operation; and
arbitration logic coupled to the processor, wherein data from the arbitration logic allows the processor to perform the at least one operation for a flash memory device.

2. The flash memory controller of claim 1 wherein the flash memory device comprises a plurality of flash memory devices.

3. The flash memory controller of claim 2 wherein the plurality of flash memory devices can comprise flash memory devices having different capacities.

4. The flash memory controller of claim 2 wherein the at least one operation can be performed simultaneously on different flash memory devices of the flash memory system.

5. The flash memory controller of claim 1 wherein the processor can utilize data from the arbitration logic to conduct a search for available blocks, wherein the search is directed to the flash memory device.

6. The flash memory controller of claim 1 further comprising an internal buffer within the flash memory device, wherein the internal buffer stores valid data during a search for available blocks.

7. The flash memory controller of claim 1 wherein the operation comprises at least one block management operation.

8. The flash memory controller of claim 7 wherein the at least one block management operation comprises one of handling bad blocks, recycling obsolete blocks, and wear leveling.

9. The flash memory controller of claim 1 wherein the flash memory controller can be applied to USB Flash Drive, Secure Digital Card, MultiMediaCard, Memory Stick, Compact Flash Card, Flash Memory Hard Drive, and ExpressCard.

10. The flash memory controller of claim 1 wherein the flash memory controller can be applied to multi-mode USB, Secure Digital (SD), MultiMediaCard (MMC), Memory Stick (MS), and Compact Flash (CF) card.

11. The flash memory controller of claim 1 wherein the flash memory controller provides multiple-block data access.

12. The flash memory controller of claim 1 wherein the flash memory controller provides dual channel processing.

13. The flash memory controller of claim 1 wherein the flash memory controller can perform multiple banks interleave.

14. The flash memory controller of claim 1 wherein the flash memory controller can perform functions of multiple block access, multiple bank interleaving, and multiple channel operations in a memory access cycle.

15. A flash memory system comprising:
a first processor;
a device interface coupled to the processor; and
a flash memory controller coupled to the device interface, the flash memory controller comprising:
a second processor for executing at least one operation; and
arbitration logic coupled to the processor, wherein data from the arbitration logic allows the processor to perform the at least one operation for a flash memory device.

16. The flash memory controller of claim 15 wherein the flash memory device comprises a plurality of flash memory devices.

17. The system of claim 16 wherein the plurality of flash memory devices can comprise flash memory devices having different capacities.

18. The system of claim 16 wherein the at least one operation can be performed simultaneously on different flash memory devices of the flash memory system.

19. The system of claim 15 wherein the second processor can utilize data from the arbitration logic to conduct a search for available blocks, wherein the search is directed to the particular flash memory device.

20. The system of claim 15 further comprising an internal buffer within the particular flash memory device, wherein the internal buffer stores valid data during a search for available blocks.

21. The system of claim 15 wherein the operation comprises at least one block management operation.

22. The system of claim 21 wherein the at least one block management operation comprises one of handling bad blocks, recycling obsolete blocks, and wear leveling.

23. The system of claim 15 wherein the flash memory controller can be applied to USB Flash Drive, Secure Digital Card, MultiMediaCard, Memory Stick, Compact Flash Card, Flash Memory Hard Drive, and ExpressCard.

24. The system of claim 15 wherein the flash memory controller can be applied to multi-mode USB, Secure Digital (SD), MultiMediaCard (MMC), Memory Stick (MS), and Compact Flash (CF) card.

25. The system of claim 15 wherein the flash memory controller provides multiple-block data access.

26. The system of claim 15 wherein the flash memory controller provides dual channel processing.

27. The system of claim 15 wherein the flash memory controller can interleave multiple blocks.

28. The system of claim 15 wherein the flash memory controller can perform functions of multiple block access, multiple bank interleaving, and multiple channel operations in a memory access cycle.

29. A method for managing flash memory in a flash memory system, the method comprising:
(a) initiating at least one operation;
(b) conducting a search for a destination block within a flash memory device; and
(c) relocating valid data within the flash memory device from a source block to the destination block, wherein the at least one operation is performed for the flash memory device.

30. The method of claim 29 wherein the flash memory device comprises a plurality of flash memory devices.

31. The method of claim 30 wherein the plurality of flash memory devices can include flash memory devices having different capacities.

32. The method of claim 30 wherein the at least one operation can be performed simultaneously on different flash memory devices of the flash memory system.

33. The method of claim 29 wherein arbitration logic provides data to a processor to direct the search to the flash memory device.

34. The method of claim 29 wherein the conducting a search step (b) further comprises (b2) storing the valid data in an internal buffer during the search.

35. The method of claim 29 wherein the at least one operation includes at least one block management operation.

36. The method of claim 35 wherein the at least one block management operation includes one of handling bad blocks, recycling obsolete blocks, and wear leveling.

37. The method of claim 29 wherein the method can be applied to USB Flash Drive, Secure Digital Card, MultiMediaCard, Memory Stick, Compact Flash Card, Flash Memory Hard Drive, and ExpressCard.

38. The method of claim 29 wherein the method can be applied to multi-mode USB, Secure Digital (SD), MultiMediaCard (MMC), Memory Stick (MS), and Compact Flash (CF) card.

39. The method of claim 29 wherein the flash memory controller provides multiple-block data access.

40. The method of claim 29 wherein the flash memory controller provides dual channel processing.

41. The method of claim 29 wherein the flash memory controller can interleave multiple blocks.

42. The method of claim 29 wherein the flash memory controller can perform functions of multiple block access, multiple bank interleaving, and multiple channel operations in a memory access cycle.

43. A computer readable medium containing program instructions for managing flash memory, the program instructions which when performed by a computer system cause the computer system to perform a method comprising:
(a) initiating at least one operation;
(b) conducting a search for a destination block within a flash memory device; and
(c) relocating valid data within the flash memory device from a source block to the destination block, wherein the at least one operation is performed for a flash memory device.

44. The computer readable medium of claim 43 wherein the flash memory device comprises a plurality of flash memory devices.

45. The computer readable medium of claim 44 wherein the plurality of flash memory devices can include flash memory devices having different capacities.

46. The computer readable medium of claim 44 wherein the at least one operation can be performed simultaneously on different flash memory devices of the flash memory system.

47. The computer readable medium of claim 43 wherein arbitration logic provides data to a processor to direct the search to the flash memory device.

48. The computer readable medium of claim 43 wherein the conducting step (b) further comprises comprising program instructions for (b2) storing the valid data in an internal buffer during the search.

49. The computer readable medium of claim 43 wherein the at least one operation includes at least one block management operation.

50. The computer readable medium of claim 49 wherein the at least one block management operation includes one of handling bad blocks, recycling obsolete blocks, and wear leveling.

51. The computer readable medium of claim 43 wherein the computer readable medium can be applied to USB Flash Drive, Secure Digital Card, MultiMediaCard, Memory Stick, Compact Flash Card, Flash Memory Hard Drive, and ExpressCard.

52. The computer readable medium of claim 43 wherein the computer readable medium can be applied to multi-mode USB, Secure Digital (SD), MultiMediaCard (MMC), Memory Stick (MS), and Compact Flash (CF) card.

53. The computer readable medium of claim 43 wherein the flash memory controller provides multiple-block data access.

54. The computer readable medium of claim 43 wherein the flash memory controller provides dual channel processing.

55. The computer readable medium of claim 43 wherein the flash memory controller can interleave multiple blocks.

56. The computer readable medium of claim 43 wherein the flash memory controller can perform functions of multiple block access, multiple bank interleaving, and multiple channel operations in a memory access cycle.
